(19) United States
(12) Patent Application Publication
(10) Pub. No.: US 2009/0166150 A1
(43) Pub. Date: Jul. 2, 2009

(54) METHOD AND APPARATUS FOR DISCRIMINATING DOCUMENTS

(75) Inventors: Akira MORI, Owariasahi (JP); Mitsunari Kanou, Seto (JP); Toshiro Uemura, Nissin (JP); Kenji Okuna, Seto (JP); Noriaki Fujimura, Owariasahi (JP)

Correspondence Address: MCDERMOTT WILL & EMERY LLP, 600 13TH STREET, N.W., WASHINGTON, DC, 20005-3096, US

(73) Assignee: HITACHI,LTD., Tokyo (JP)

(21) Appl. No.: 12/264,663

(22) Filed: Nov. 4, 2008

Related U.S. Application Data
(63) Continuation of application No. 10/743,699, filed on Dec. 23, 2003, now abandoned.

(30) Foreign Application Priority Data
Mar. 13, 2003 (JP) 2003-067451

(51) Int. Cl. G07D 5/00; G07F 7/04

(52) U.S. Cl. 194/207; 194/303

(57) ABSTRACT

In a discrimination apparatus of the invention, a banknote or another paper as an object of discrimination is irradiated with ultraviolet radiation from an array of multiple ultraviolet-emitting LEDs. The ultraviolet radiation passes through a visible radiation block filter and is focused onto a preset site of the banknote by a lens. Multiple photodiodes are used to measure the transmitted light of ultraviolet radiation and the fluorescence, which is excited by the ultraviolet radiation from the banknote. The discrimination apparatus of the invention discriminates counterfeit banknotes from genuine banknotes, based on the observed pattern of the transmitted light over a preset range of the banknote. The technique of the invention desirably enhances the accuracy of discrimination in the discrimination apparatus that discriminates counterfeit banknotes from genuine banknotes.

### BACKGROUND OF THE INVENTION

The present invention relates to a technique of enhancing the detection accuracy of forgery in a discrimination apparatus that discriminates counterfeit papers and documents from genuine papers and documents.

Automatic teller machines handling banknotes and various securities have been used widely. Such automatic teller machines generally include a discrimination apparatus to discriminate counterfeit banknotes and documents from genuine banknotes and documents.

The paper is determined as counterfeit or as genuine by taking advance of reflected light or secondary light, which is obtained by predetermined light irradiation, such as ultraviolet radiation or infrared radiation. The secondary light represents fluorescence emission or infrared emission excited by irradiation of ink or paper.

The techniques disclosed in JP2000-296687A and JP2001-52232A use transmitted light or reflected light of fluorescence for discrimination. The technique disclosed in U.S. Pat. No. 5,640,463 uses reflected light of ultraviolet radiation for discrimination.

### SUMMARY OF THE INVENTION

The discrimination technique of banknotes and various documents has regretfully been advanced, and improvement of the forgery detection technique or the discrimination technique has highly been demanded. The object of the present invention is thus to diversify and improve the discrimination technique of banknotes and various documents by utilizing irradiated light.

In a discrimination apparatus of the invention, an ultraviolet emission module irradiates a paper as an object of discrimination with ultraviolet radiation. A transmitted light measurement module measures intensity of transmitted light of ultraviolet radiation, which is transmitted through the paper. A discrimination module determines the paper as counterfeit or as genuine, based on the observed intensity of the transmitted light. None of the known techniques has used the transmitted light of ultraviolet radiation for discrimination. The inventors of the present invention have made extensive experiments and have found that the transmitted light of ultraviolet radiation may discriminate counterfeit of some papers and documents from genuine ones with higher accuracy than the reflected light of ultraviolet radiation. The technique of the invention is based on this finding and carries out discrimination based on the observed intensity of the transmitted light of ultraviolet radiation. This arrangement effectively enhances the accuracy of discrimination.

The paper as the object of discrimination in the invention represents any paper, film sheet, or card having the values given by printing of letters, figures, and characters. Typical examples of the paper include banknotes, lotteries including those run by the government and other authorities, betting tickets of horse races, bicycle races, and boat races, admission tickets, railway, passage, and boarding tickets, highway cards, telephone cards, tickets of various facilities, securities, stocks, bonds, and book coupons.

In one preferable embodiment, the discrimination apparatus of the invention measures intensity of fluorescence, which is excited by the ultraviolet radiation from the paper, and determines the paper as counterfeit or as genuine, based on the observed intensity of the fluorescence as well as the observed intensity of the transmitted light. The fluorescence may be measured on the side of the irradiation of the paper or may be measured on the side of the measurement of the transmitted light. Combination of the multiple means further enhances the accuracy of discrimination. The fluorescence is excited by the ultraviolet radiation, so that the common ultraviolet emission module is advantageously used for measurement of both the intensities of the transmitted light and the fluorescence.

In another preferable embodiment, the discrimination apparatus of the invention measures the intensity of the transmitted light at multiple different positions on the paper, and determines the paper as counterfeit or as genuine, based on measurement results at the multiple different positions. This arrangement further enhances the accuracy of discrimination. The intensity of the fluorescence, as well as the intensity of the transmitted light, may be measured at multiple different positions.

In the discrimination apparatus of the invention, a conveyor unit may be provided to convey the paper relative to the ultraviolet emission module and the transmitted light measurement module. The conveyor unit may shift the paper or may alternatively shift the ultraviolet emission module or the transmitted light measurement module. In this structure, the multiple different positions may be set in a conveying direction (hereafter referred to as the main scanning direction). This relatively simple structure enables measurement at the multiple different positions, simultaneously with conveyance of the paper. The arrangement of the multiple different positions is not restricted to the main scanning direction, but may be in a direction perpendicular to the conveying direction (hereafter referred to as the sub-scanning direction).

In order to attain the measurement at the multiple different positions, multiple ultraviolet-emitting elements may be located at multiple different positions, or multiple transmitted light-receiving elements or multiple fluorescence-receiving elements may be located at multiple different positions. Application of such an array structure for the ultraviolet emission module or for the transmitted light measurement module or the fluorescence measurement module ensures simultaneous measurement at the multiple different positions and thus desirably shortens the total time of discrimination. The light-emitting elements and the light-receiving elements in such an array structure are positioned in advance. This effectively enhances the positional accuracy of discrimination.

In the array structure, it is preferable that the respective elements are arranged in the sub-scanning direction. This array structure facilitates measurement at multiple two-dimensionally located sites on the conveyed paper.

The results of the measurement at the multiple different positions are utilized in various ways. For example, one available procedure compares the measurement results at the multiple different positions with a pattern, which is stored in advance to represent an allowable range of intensity of transmitted light measured at the multiple different positions and to give a criterion of determination of a genuine paper. In this application, the paper may be determined as genuine, when at least a predetermined rate of the observed intensity of the transmitted light at the multiple different positions is included in the allowable range. In an extreme case, the paper may be determined as genuine when all the measurement results are in the allowable range. In another extreme case, the paper may be determined as genuine when one of the measurement results is in the allowable range.

The technique of the invention is actualized by a diversity of other applications including a discrimination method, as well as the discrimination apparatus discussed above.

### BRIEF DESCRIPTION OF THE DRAWINGS

FIG. 1 schematically illustrates the construction of a discrimination apparatus in one embodiment of the invention;

FIG. 2 is an enlarged view of the optical unit;

FIG. 3 is an enlarged sectional view of the optical unit seen in the sub-scanning direction;

FIG. 4 shows a genuine banknote pattern as an example;

FIG. 5 is a flowchart showing a discrimination routine;

FIG. 6 illustrates an optical unit of a first modified example;

FIG. 7 is an enlarged sectional view of the optical unit of the first modified example seen in the sub-scanning direction;

FIG. 8 is an enlarged sectional view of the optical unit of the first modified example seen in the main scanning direction;

FIG. 9 illustrates an optical unit of a second modified example;

FIG. 10 is an enlarged sectional view of the optical unit of the second modified example seen in the sub-scanning direction;

FIG. 11 is an enlarged sectional view of the optical unit of the second modified example seen in the main scanning direction;

FIG. 12 is an enlarged sectional view of an optical unit of a third modified example seen in the sub-scanning direction;

FIG. 13 is an enlarged sectional view of an optical unit of a fourth modified example seen in the sub-scanning direction;

FIG. 14 illustrates an optical unit of a fifth modified example; and

FIG. 15 illustrates an optical unit of a sixth modified example.

### DESCRIPTION OF THE EMBODIMENTS

A discrimination apparatus that discriminates counterfeit banknotes from genuine banknotes is discussed below as one embodiment of the invention in the following sequence:

A. Construction of Discrimination apparatus and Discrimination Process

B. Modifications of Optical Unit

B1. Modified Example (1)

B2. Modified Example (2)

B3. Modified Example (3)

B4. Modified Example (4)

B5. Modified Example (5)

B6. Modified Example (6)

C. Other Modifications

### A. Construction of Discrimination Apparatus and Discrimination Process

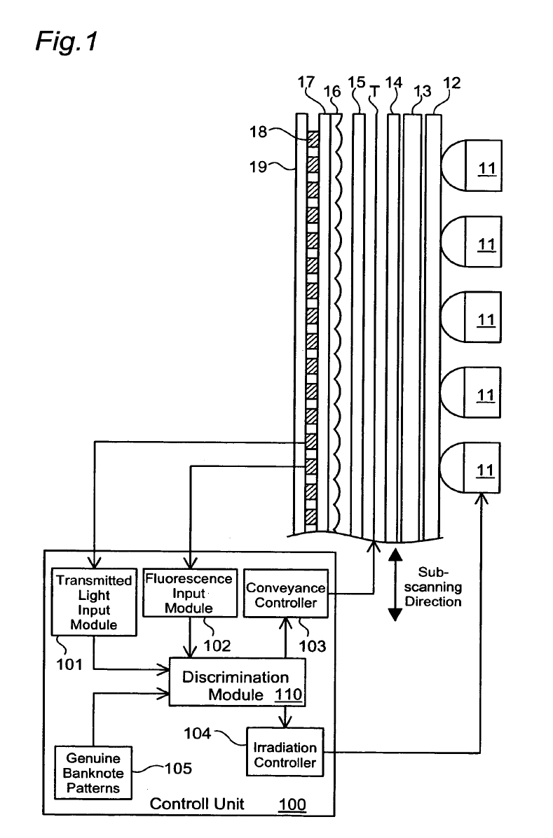

FIG. 1 schematically illustrates the construction of a discrimination apparatus in one embodiment of the invention. The discrimination apparatus of the embodiment is used to discriminate counterfeit banknotes from genuine banknotes and is incorporated in, for example, an automated teller machine.

The upper drawing is a side view showing the inside of the discrimination apparatus. Banknotes are conveyed along a conveyor path T from the surface to the rear face of the illustration. An optical sensor for detecting the conveying position of the banknote is provided on the conveyor path T, although being omitted from the illustration. The conveying direction is hereafter referred to as the main scanning direction, and the direction perpendicular to the main scanning direction is referred to as the sub-scanning direction.

The discrimination apparatus has multiple ultraviolet-emitting LEDs 11, which are arranged at equal intervals in the sub-scanning direction. Transmitted light of ultraviolet radiation, which is emitted from the ultraviolet-emitting LEDs 11 and is transmitted through the banknote conveyed along the conveyor path T, is detected by multiple photodiodes 18 arranged on a substrate 19. An amplification circuit for amplifying the signals detected by the photodiodes 18 may also be provided on the substrate 19. The mechanism of irradiating ultraviolet radiation and receiving transmitted light and fluorescence is hereafter collectively referred to as the optical unit.

An optical mechanism is interposed between the ultraviolet-emitting LEDs 11 and the photodiodes 18 to measure the intensity of the transmitted light of ultraviolet radiation at multiple different points of the banknote with high accuracy. A visible radiation block filter 12 functions to exclude visible radiation from the light emission of the ultraviolet-emitting LEDs 11. A lens 13 functions to focus the ultraviolet radiation onto a preset site of the banknote.

Protective glasses 14 and 15 protect the elements of the optical unit from the banknotes. Another lens 16 functions to focus the transmitted light of ultraviolet radiation, which is transmitted through the banknote, onto the photodiodes 18. A filter 17 allows selective transmission of the transmitted light of ultraviolet radiation and fluorescence excited by the ultraviolet radiation. The structure of the filter 17 will be discussed later. In the arrangement of this embodiment, the respective lenses 13 and 16 and the protective glasses 14 and 15 are composed of a material that allows transmission of the ultraviolet radiation but prohibits excitation of fluorescence by the ultraviolet radiation.

The discrimination apparatus of the embodiment has a control unit 100 that controls the operations of the respective elements including the ultraviolet-emitting LEDs 11 and discriminates counterfeit banknotes from genuine banknotes. In the structure of this embodiment, the control unit 100 is constructed by a microcomputer including a CPU, a ROM, and a RAM.

The lower drawing shows functional blocks of the control unit 100. These functional blocks are attained by the software configuration, which is recorded in the ROM to exert the functions of discrimination. The respective functional blocks may alternatively be actualized by the hardware construction.

A discrimination module 110 controls the other functional blocks and functions to discriminate counterfeit banknotes from genuine banknotes. A conveyance controller 103 controls the conveyor path T and conveys banknotes as objects of discrimination. An irradiation module 104 regulates the ultraviolet-emitting LEDs 11 to irradiate a banknote with ultraviolet radiation, when the banknote reaches a preset position.

When the banknote is irradiated with the ultraviolet radiation, a transmitted light input module 101 receives the observed intensity of the transmitted light, which is transmitted through the banknote, from the photodiodes 18. A fluorescence input module 102 receives the observed intensity of the fluorescence, which is excited by the ultraviolet radiation, from the photodiodes 18. Genuine banknote patterns 105 represent prerecorded detection patterns of the intensity of transmitted light and the intensity of fluorescence, which are expected when the banknote is genuine. The discrimination module 110 compares the observed intensity of the transmitted light and the observed intensity of the fluorescence with regard to each banknote as the object of discrimination with the genuine banknote patterns 105 and determines the banknote as counterfeit or as genuine.

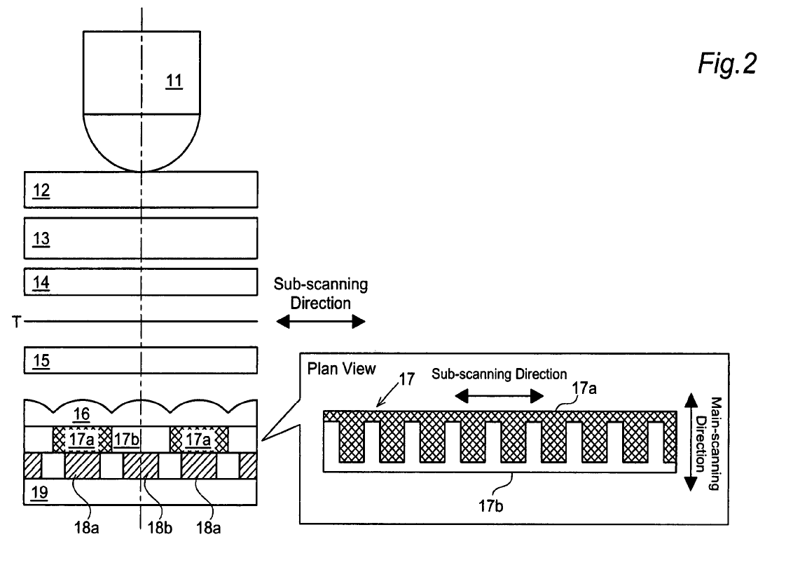

FIG. 2 is an enlarged view of the optical unit. As discussed above, among the elements of the optical unit, the visible radiation block filter 12, the lens 13, and the protective glass 14 are disposed in this sequence between the ultraviolet-emitting LEDs 11 and the conveyor path T. The protective glass 15, the lens 16, and the filter 17 are disposed in this sequence between the conveyor path T and the substrate 19 with the photodiodes 18 mounted thereon.

The right drawing is a plan view of the filter 17. The filter 17 of the embodiment is formed as an assembly of two filters, that is, a visible radiation block filter 17a and an ultraviolet radiation block filter 17b. The respective filters 17a and 17b of the filter assembly are arranged to alternately cover the photodiodes 18. As shown in the left drawing, photodiodes 18a covered with the visible radiation block filter 17a measure the transmitted light of ultraviolet radiation, which is transmitted through the banknote. Photodiodes 18b covered with the ultraviolet radiation block filter 17b, on the other hand, measure the fluorescence, which is excited by the ultraviolet radiation.

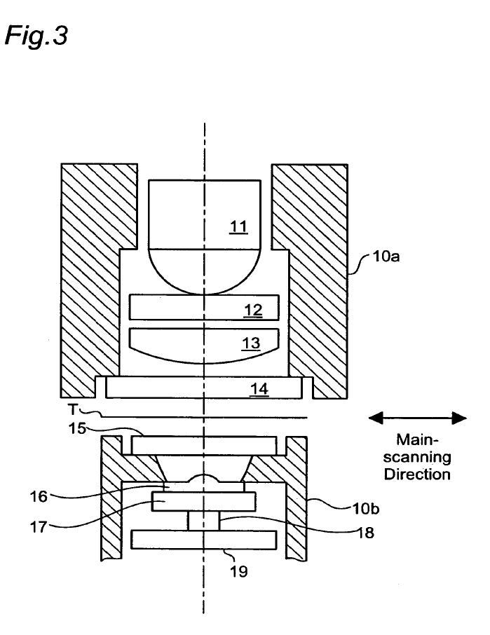

FIG. 3 is an enlarged sectional view of the optical unit seen in the sub-scanning direction. As illustrated, the ultraviolet-emitting LEDs 11, the visible radiation block filter 12, the lens 13, and the protective glass 14 are incorporated in a structural member 10a to form a light-emitting assembly of the optical unit, whereas the protective glass 15, the lens 16, the filter 17, the photodiodes 18, and the substrate 19 are incorporated in a structural member 10b to form a light-receiving assembly of the optical unit.

The device of the embodiment adopts the structure that is capable of measuring the transmitted light of ultraviolet radiation and the fluorescence simultaneously. One possible modification may adopt the structure that is capable of measuring only the transmitted light of ultraviolet radiation. This modified structure is actualized, for example, by applying a visible radiation block filter over the whole surface of the filter 17.

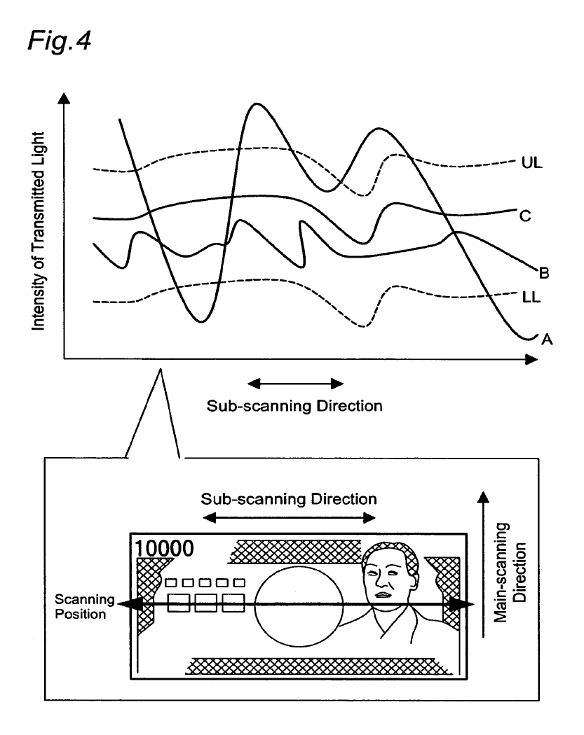

FIG. 4 shows a genuine banknote pattern as an example. The banknote is conveyed in the orientation having its longitudinal axis in the sub-scanning direction, as shown in the lower drawing. Irradiation of the banknote with the ultraviolet radiation starts when a preset scanning position of the banknote reaches the ultraviolet-emitting LEDs 11.

The genuine banknote pattern represents an intensity pattern of transmitted light of ultraviolet radiation measured at the preset scanning position of a genuine banknote, and is set corresponding to each type of banknote. In the structure of this embodiment, as shown by the broken lines in the upper drawing, an allowable intensity range of genuine banknotes is defined by an upper limit curve UL and a lower limit curve LL. When the observed intensity pattern of the transmitted light measured with regard to each banknote as the object of discrimination is included in the allowable range defined by the upper limit curve UL and the lower limit curve LL as in the case of solid-line curves B and C, the banknote is determined as genuine. When the observed intensity pattern of the transmitted light is deviated from the allowable range as in the case of a solid-line curve A, on the other hand, the banknote is determined as counterfeit.

A diversity of settings may be allowed as the criterion of discrimination. The above procedure determines the banknote as counterfeit when even part of the observed intensity pattern is deviated from the allowable range. One possible modification may determine the banknote as counterfeit when at least a predetermined rate of the observed intensity pattern is deviated from the allowable range. Another possible modification may determine the banknote as genuine when even part of the observed intensity pattern is included in the allowable range.

The storage of the allowable range is not restrictive at all. For example, a mean intensity calculated from measurement results of genuine banknotes may alternatively be stored as the genuine banknote pattern. The procedure in this modified structure determines whether a difference between the observed intensity pattern of each object of discrimination and the stored genuine banknote pattern is within or out of a preset allowable error range to discriminate counterfeit banknotes from genuine banknotes. The illustration shows the genuine banknote pattern with regard to the transmitted light of ultraviolet radiation. The genuine banknote pattern is also prepared with regard to the fluorescence.

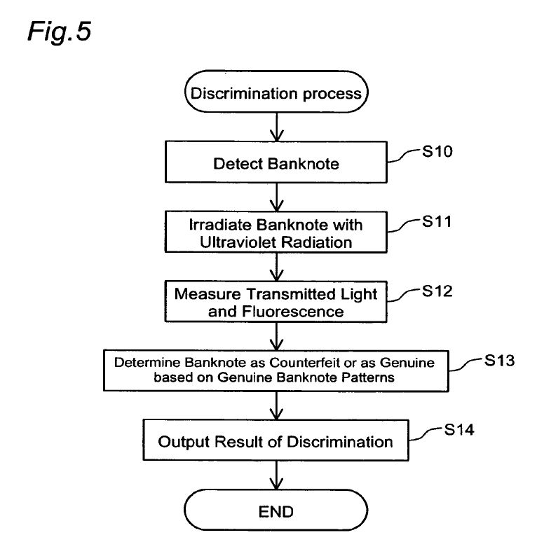

FIG. 5 is a flowchart showing a discrimination routine, which is executed by the control unit 100 in the course of conveyance of each banknote. The control unit 100 detects conveyance of the banknote to the scanning position shown in FIG. 4 (step S10), irradiates the banknote with ultraviolet radiation (step S11), and measures the intensities of the transmitted light of ultraviolet radiation and the fluorescence (step S12). The control unit 100 compares the observed intensities of the transmitted light of ultraviolet radiation and the fluorescence with the corresponding genuine banknote patterns 105 and determines the banknote as counterfeit or as genuine (step S13). The type of banknote may be specified by another mechanism, and the control unit 100 receives the result of the specification. Alternatively the discrimination apparatus itself may scan the image of each banknote and specify the tape of banknote through a series of image processing. The control unit 100 outputs the results of the discrimination (step S14), and exits from this discrimination routine.

### B. Modifications of Optical Unit

### B1. Modified Example (1)

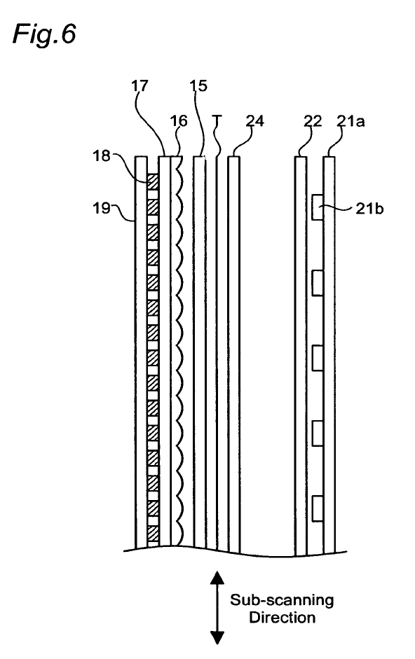

FIG. 6 illustrates an optical unit of a first modified example. In the optical unit of the first modified example, the structure of a light-receiving assembly (on the left side of the conveyor path T in FIG. 6) is identical with that of the light-receiving assembly included in the optical unit of the embodiment discussed above. The optical unit of the first modified example has ultraviolet-emitting LED chips 21b, which are arranged at identical intervals on a substrate 21a. The ultraviolet radiation from the chips 21b passes through a visible radiation block filter 22 and a protective glass 24 to reach each banknote conveyed along the conveyor path T.

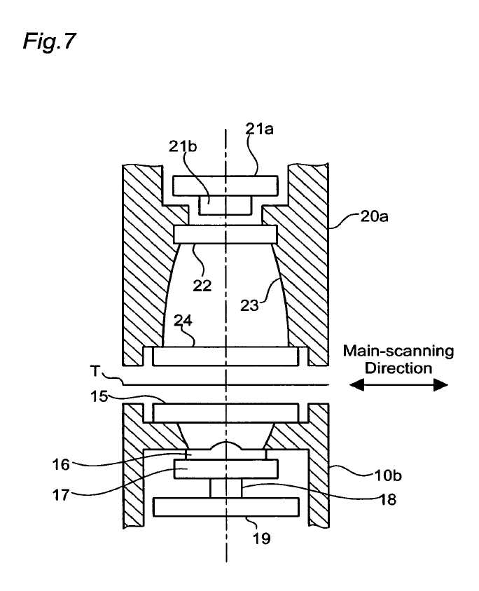

FIG. 7 is an enlarged sectional view of the optical unit of the first modified example seen in the sub-scanning direction. As illustrated, the substrate 21a, the chips 21b, the visible radiation block filter 22, and the protective glass 24 are incorporated in a structural member 20a to form a light-emitting assembly of the optical unit. The structural member 20a has an inner reflection surface 23, which is formed between the visible radiation block filter 22 and the protective glass 24 in an elliptic cylindrical shape having the longitudinal axis in the sub-scanning direction and is covered with a reflective coat to reflect the ultraviolet radiation. The ultraviolet emission from the chips 21b is reflected by the reflection surface 23 to be focused on a preset site of the banknote.

The protective glass 15, the lens 16, the filter 17, the photodiodes 18, and the substrate 19 are incorporated in the structural member 10b to form a light-receiving assembly of the optical unit. The functions of these optical elements are identical with those of the optical elements of the embodiment and are thus not specifically described here.

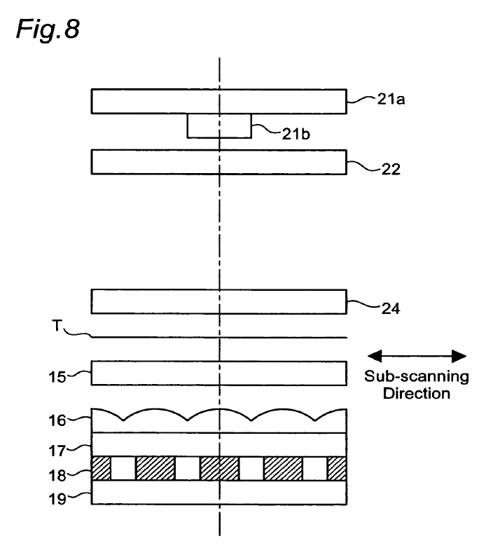

FIG. 8 is an enlarged sectional view of the optical unit of the first modified example seen in the main scanning direction. In the structure of the first modified example, one chip 21b is arranged corresponding to three photodiodes 18. The density of the chips 21b may be varied to be denser or to be sparser, according to the requirements.

### B2. Modified Example (2)

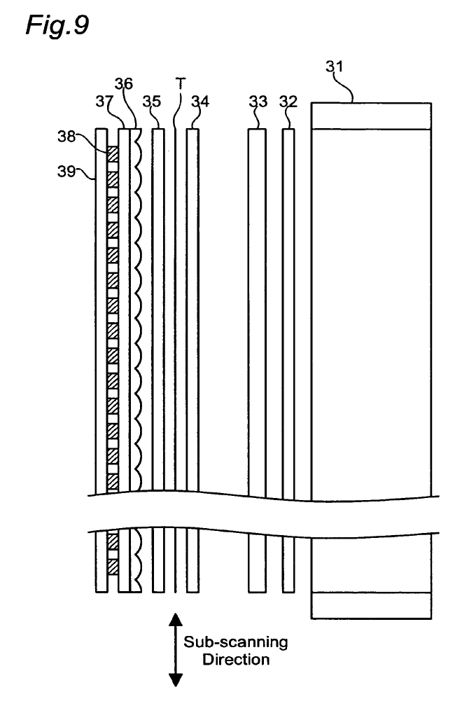

FIG. 9 illustrates an optical unit of a second modified example. The optical unit of the second modified example has an ultraviolet emission tube 31 on its light-receiving side. The ultraviolet radiation from the ultraviolet emission tube 31 passes through a visible radiation block filter 32, a lens 33, and a protective glass 34 to reach each banknote conveyed along the conveyor path T. The lens 33 functions to focus the ultraviolet radiation onto a preset site of the banknote. A protective glass 35, a lens 36, a filter 37, photodiodes 38, and a substrate 39 are arranged as illustrated to form a light-receiving assembly of the optical unit.

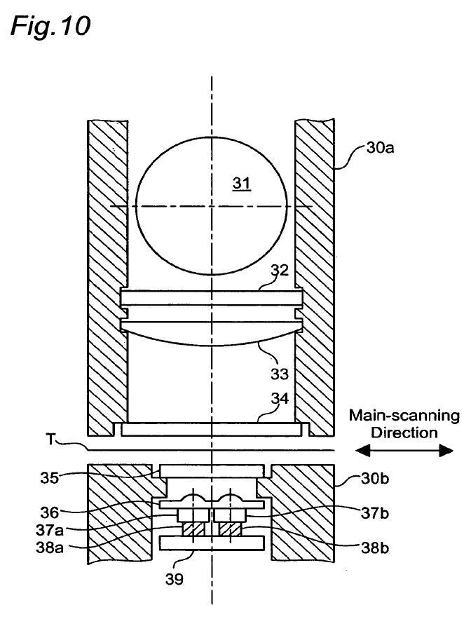

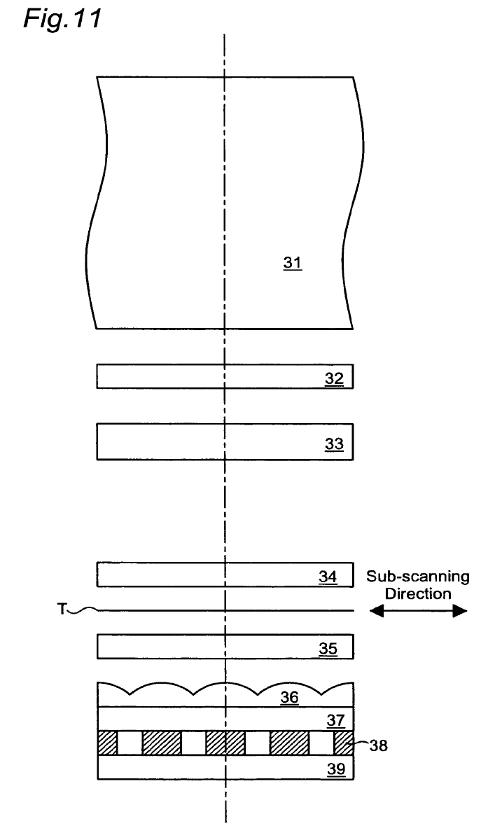

FIG. 10 is an enlarged sectional view of the optical unit of the second modified example seen in the sub-scanning direction, and FIG. 11 is an enlarged sectional view of the optical unit of the second modified example seen in the main scanning direction. As illustrated, the ultraviolet emission tube 31, the visible radiation block filter 32, the lens 33, and the protective glass 34 are incorporated in a structural member 30a to form a light-emitting assembly of the optical unit.

The respective optical elements of the light-receiving assembly are mounted on a structural member 30b as illustrated. In the structure of the second modified example, photodiodes 38a for receiving the transmitted light of ultraviolet radiation and photodiodes 38b for receiving the fluorescence are arranged in parallel in the main scanning direction on the substrate 39. The top face of the photodiodes 38a for receiving the transmitted light of ultraviolet radiation is covered with a visible radiation block filter 37a, whereas the top face of the photodiodes 38b for receiving the fluorescence is covered with an ultraviolet radiation block filter 37b. The lens 36 is designed to focus the transmitted light of ultraviolet radiation and the fluorescence onto the respective photodiodes 38a and 38b.

### B3. Modified Example (3)

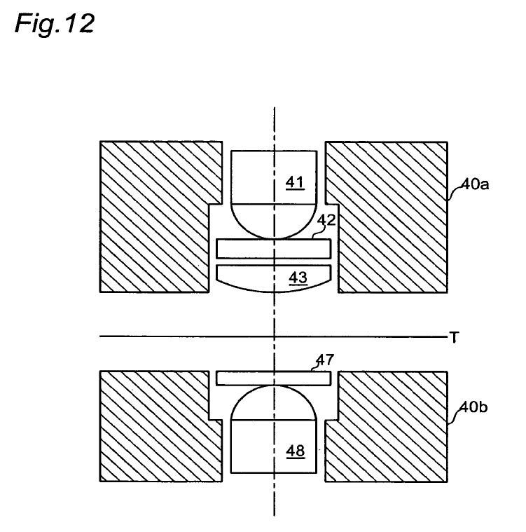

FIG. 12 is an enlarged sectional view of an optical unit of a third modified example seen in the sub-scanning direction. A large number of the optical units are arranged in the sub-scanning direction to form an array.

As illustrated, ultraviolet-emitting LEDs 41, a visible radiation block filter 42, and a lens 43 are incorporated in a structural member 40a to form a light-emitting assembly of the optical unit. The light-emitting assembly may further include a protective glass. A visible radiation block filter 47 and photodiodes 48 are incorporated in a structural member 40b to form a light-receiving assembly of the optical unit. The light-receiving assembly may further include a protective glass and a lens.

### B4. Modified Example (4)

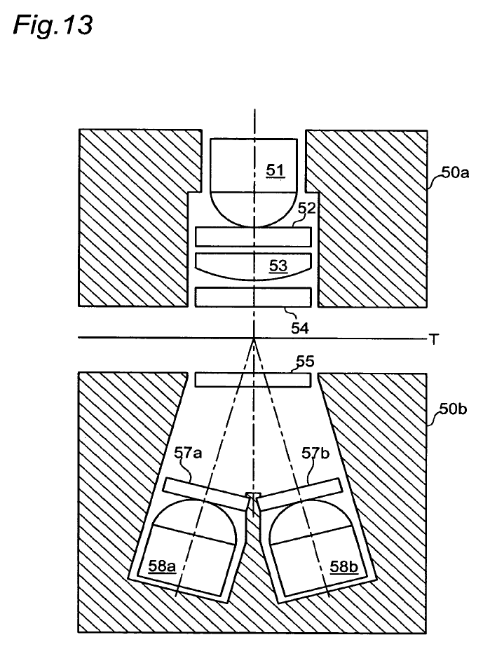

FIG. 13 is an enlarged sectional view of an optical unit of a fourth modified example seen in the sub-scanning direction. A large number of the optical units are arranged in the sub-scanning direction to form an array.

As illustrated, ultraviolet-emitting LEDs 51, a visible radiation block filter 52, a lens 53, and a protective glass 54 are incorporated in a structural member 50a to form a light-emitting assembly of the optical unit.

In a light-receiving assembly of the optical unit, photodiodes 58a for receiving the transmitted light of ultraviolet radiation and photodiodes 58b for receiving the fluorescence are located below a protective glass 55 and are incorporated in a structural member 50b. The front face of the photodiodes 58a for receiving the transmitted light of ultraviolet radiation is covered with a visible radiation block filter 57a, whereas the front face of the photodiodes 58b for receiving the fluorescence is covered with an ultraviolet radiation block filter 57b. The ultraviolet-emitting LEDs 51 and the photodiodes 58a and 58b are arranged to cross their optical axes on the conveyor path T. This relatively simple positional relation enables the transmitted light through the banknote and the fluorescence to be received by the corresponding photodiodes 58a and 58b, when the banknote is irradiated with the ultraviolet radiation.

### B5. Modified Example (5)

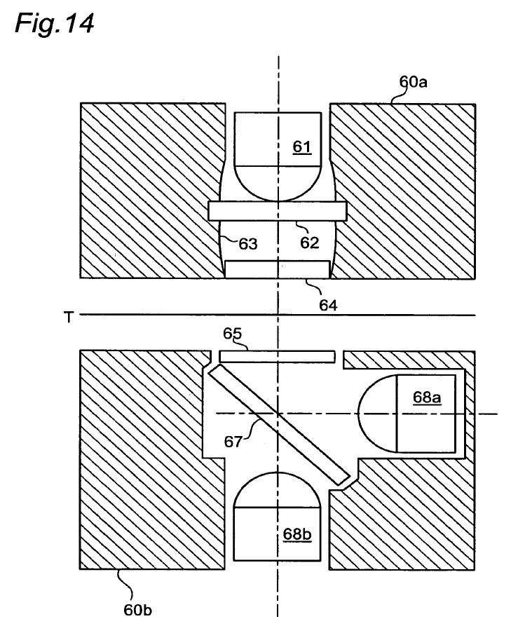

FIG. 14 illustrates an optical unit of a fifth modified example seen in the sub-scanning direction. As illustrated, in a light-emitting assembly of the optical unit, ultraviolet-emitting LEDs 61 arranged at identical intervals, a visible radiation block filter 62, and a protective glass 64 are incorporated in a structural member 60a. The structural member 60a has an inner reflection surface 63, which is formed between the visible radiation block filter 62 and the protective glass 64 in an elliptic cylindrical shape having the longitudinal axis in the sub-scanning direction and is covered with a reflective coat to reflect the ultraviolet radiation.

The respective optical elements of a light-receiving assembly are mounted on a structural member 60b as illustrated. A light reflector 67 is disposed below a protective glass 65 to selectively reflect the ultraviolet radiation, while allowing transmission of the residual light component therethrough. Photodiodes 68a for measuring the ultraviolet radiation are located on the side of the light reflector 67, and photodiodes 68b for measuring the fluorescence are located below the light reflector 67. The transmitted light of ultraviolet radiation through the banknote is reflected by the light reflector 67 and is measured by the photodiodes 68a. The fluorescence excited by the ultraviolet radiation is transmitted through the light reflector 67 and is measured by the photodiodes 68b.

### B6. Modified Example (6)

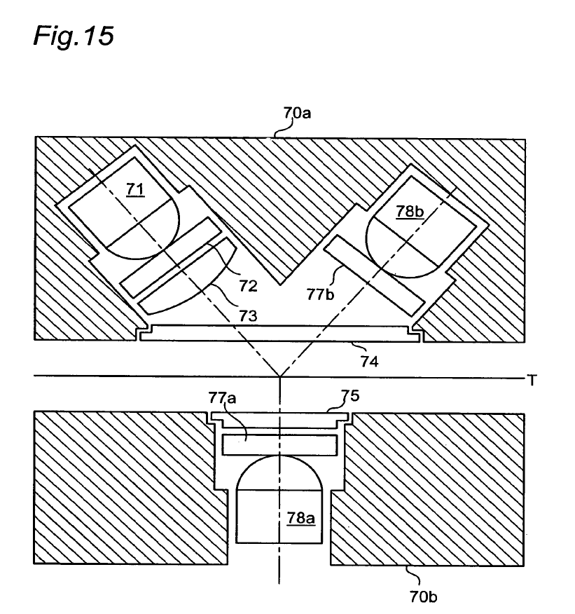

FIG. 15 illustrates an optical unit of a sixth modified example seen in the sub-scanning direction. The optical unit of the sixth modified example is designed to measure the fluorescence in a light-emitting assembly.

The respective optical elements of the light-emitting assembly are mounted on a structural member 70a as illustrated. Ultraviolet-emitting LEDs 71 arranged at identical intervals, a visible radiation block filter 72, and a lens 73 are oriented to be inclined to the conveyor path T. Photodiodes 78b for measuring the fluorescence are located axisymmetrical to the ultraviolet-emitting LEDs 71. The front face of the photodiodes 78b is covered with an ultraviolet radiation block filter 77b. These optical elements are protected by a protective glass 74.

The respective optical elements of a light-receiving assembly are mounted on a structural member 70b as illustrated. A visible radiation block filter 77a and photodiodes 78a for measuring the ultraviolet radiation are located under a protective glass 75.

In the structure of the sixth modified example, the transmitted light of the ultraviolet radiation, which is emitted from the ultraviolet-emitting LEDs 71 and is transmitted through the banknote, is measured by the photodiodes 78a, while the fluorescence is measured by the photodiodes 78b. For efficient measurement of the transmitted light and the fluorescence, the ultraviolet-emitting LEDs 71 and the photodiodes 78a and 78b are arranged to cross their optical axes at an angle of 120 degrees.

### C. Other Modifications

In any of the embodiment and its modified examples discussed above, the intensities of the transmitted light of ultraviolet radiation and the fluorescence are measured at the preset scanning position in the main scanning direction. While the bank note is being conveyed, the banknote may be scanned at multiple different positions in the main scanning direction. Such scanning with an array that is capable of measuring the intensities at multiple different positions in the sub-scanning direction enables measurement at each two-dimensionally located site on the surface of the banknote. This desirably enhances the accuracy of discrimination.

The structure of the embodiment uses the array of photodiodes. A single photodiode may alternatively be used for the measurement. One available structure measures the intensities by moving the single photodiode either in the sub-scanning direction or in the main scanning direction. The array structure is, however, advantageous to complete the measurement at multiple different positions in a short time period. Compared with the measurement with the shift of the single photodiode, the arrangement of the embodiment advantageously enhances the precision of positioning for measurement and thus heightens the accuracy of discrimination.

As described above, the technique of the invention utilizes the transmitted light of ultraviolet radiation to discriminate counterfeit papers and documents from genuine papers and documents with high accuracy.

The above embodiment and its modified examples are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

1. A discrimination apparatus that detects a counterfeit paper, said discrimination apparatus comprising:
an ultraviolet emission module that irradiates a paper as an object of discrimination with ultraviolet radiation;
a transmitted light measurement module having a plurality of ultraviolet light detection elements each measuring intensity of simultaneously transmitted light of ultraviolet radiation, which is transmitted through the paper;
a fluorescence measurement module having a plurality of fluorescence detection elements each measuring intensity of fluorescence, which is excited from the paper by the ultraviolet radiation; and
a discrimination module that determines the paper as counterfeit or as genuine, based on the observed intensity of the simultaneously transmitted light and the observed intensity of the fluorescence;
wherein the ultraviolet light detection elements and the fluorescence detection elements are disposed alternately with each other in a linear arrangement along a direction perpendicular to paper transportation direction.
Claims 2-3. (canceled)

4. A discrimination apparatus in accordance with claim 1, said discrimination apparatus further comprising:
a conveyor unit that conveys the paper relative to said ultraviolet emission module and said transmitted light measurement module in the paper transportation direction,
wherein the multiple different positions include a site set in a conveying direction.

5. A discrimination apparatus in accordance with claim 1, wherein said ultraviolet emission module has multiple ultraviolet-emitting elements, which are located at multiple different positions to irradiate the paper with the ultraviolet radiation.

6. A discrimination apparatus in accordance with claim 1, wherein said transmitted light measurement module has multiple transmitted light-receiving elements, which are located at multiple different positions to measure the intensity of the transmitted light at the multiple different positions.

7. (canceled)

8. A discrimination apparatus in accordance with claim 1, said discrimination apparatus further comprising:
a conveyor path, along which the paper is conveyed in the paper transportation direction,
wherein said ultraviolet emission module is arranged to face said transmitted light measurement module across the conveyor path.

9. A discrimination apparatus in accordance with claim 1, said discrimination apparatus further comprising:
a conveyor path, along which the paper is conveyed in the paper transportation direction,
wherein said ultraviolet emission module is arranged to face said transmitted light measurement module and said fluorescence measurement module across the conveyor path.

10. A discrimination apparatus in accordance with claim 1, said discrimination apparatus further comprising:
a conveyor path, along which the paper is conveyed in the paper transportation direction,
wherein said ultraviolet emission module and said fluorescence measurement module are arranged to face said transmitted light measurement module across the conveyor path.

11. A discrimination apparatus in accordance with claim 1, said discrimination apparatus further comprising:
a visible radiation block filter that excludes visible radiation from the light emission of said ultraviolet emission module,
wherein said visible radiation block filter is located between said ultraviolet emission module and the conveyor path.

12. A discrimination apparatus in accordance with claim 1, said discrimination apparatus further comprising:
a visible radiation block filter that is located between said transmitted light measurement module and a paper conveyor path to exclude visible radiation; and
an ultraviolet radiation block filter that is located between said fluorescence measurement module and the conveyor path to exclude ultraviolet radiation.

13. A discrimination apparatus in accordance with claim 1, said discrimination apparatus further comprising:
a light reflector that reflects ultraviolet radiation, while allowing transmission of a residual light component,
wherein said light reflector is located between said fluorescence measurement module and a paper conveyor path to lead reflected light from said light reflector to said transmitted light measurement module.

14. A discrimination apparatus in accordance with claim 1, said discrimination apparatus further comprising:
a conveyor path, along which the paper is conveyed in the paper transportation direction; and
protective glasses that are respectively located between said ultraviolet emission module and the conveyor path and between said transmitted light measurement module and the conveyor path, said protective glasses being composed of a material that allows transmission of ultraviolet radiation but prohibits excitation of fluorescence by the ultraviolet radiation.

15. A discrimination apparatus in accordance with claim 1, said discrimination apparatus further comprising:
a conveyor path, along which the paper is conveyed in the paper transportation direction;
a visible radiation block filter that excludes visible radiation from the light emission of said ultraviolet emission module; and
a protective glass composed of a material that allows transmission of ultraviolet radiation but prohibits excitation of fluorescence by the ultraviolet radiation,
wherein said ultraviolet emission module, said visible radiation block filter, and said protective glass are arranged in this sequence relative to the conveyor path, and
a reflection surface covered with a reflective coat for reflecting ultraviolet radiation is formed between said visible radiation block filter and said protective glass.

16. A discrimination method that detects a counterfeit paper, said discrimination method comprising:
irradiating a paper as an object of discrimination with ultraviolet radiation;
using a plurality of ultraviolet light detection elements, measuring intensity of simultaneously transmitted light of ultraviolet radiation, which is transmitted through the paper;
using each of a plurality of fluorescence detection elements, measuring intensity of fluorescence, which is excited from the paper by the ultraviolet radiation; and
determining the paper as counterfeit or as genuine, based on the observed intensity of the simultaneously transmitted light and the observed intensity of the fluorescence,
wherein the ultraviolet light detection elements and the fluorescence detection elements are disposed alternately with each other in a linear arrangement along a direction perpendicular to paper transportation direction.

17. (Canceled)

18. A discrimination apparatus that detects a counterfeit paper, said discrimination apparatus comprising:
an ultraviolet emission module that irradiates a paper as an object of discrimination with ultraviolet radiation;
a transmitted light measurement module having a plurality of ultraviolet light detection elements each measuring intensity of simultaneously transmitted light of ultraviolet radiation, which is transmitted through the paper;
a fluorescence measurement module having a plurality of fluorescence detection elements each measuring intensity of fluorescence, which is excited from the paper by the ultraviolet radiation; and
a discrimination module that determines the paper as counterfeit or as genuine, based on the measured intensity of the simultaneously transmitted light and the measured intensity of the fluorescence; wherein:
the ultraviolet light detection elements are arranged in a first row, the fluorescence detection elements are arranged in a second row, the first row is parallel with the second row and not co-linear with the second row, and the optical axis of at least one ultraviolet light detection element and the optical axis of at least one fluorescent detection element intersect with each other on the paper, and
the ultraviolet light detection elements and the fluorescence detection elements are disposed alternately with each other along a direction perpendicular to paper transportation direction.
